(19) United States
(12) Patent Application Publication
(10) Pub. No.: US 2017/0211469 A1
(43) Pub. Date: Jul. 27, 2017

(54) INTERNAL COMBUSTION ENGINE

(71) Applicant: Bahador Riazati, Greenwood Village, CO (US)

(72) Inventor: Bahador Riazati, Greenwood Village, CO (US)

(21) Appl. No.: 15/413,988

(22) Filed: Jan. 24, 2017

Related U.S. Application Data
(60) Provisional application No. 62/286,586, filed on Jan. 25, 2016.

(51) Int. Cl. F02B 75/02; F16F 15/24; F02B 75/04; F02B 75/24; F01L 1/04; F01M 11/00

(52) U.S. Cl. CPC F02B 75/02; F01L 1/04; F01M 11/0004; F02B 75/04; F02B 75/24; F16F 15/24; F02B 2075/027; F02B 2075/1808

(57) ABSTRACT

Disclosed are four-stroke internal combustion engines and engine modules. The engine modules described herein convert linear reciprocating motion of a piston within a cylinder to rotational motion of a flywheel, which rotates around the cylinder's axis, or to rotational motion of the cylinder, which rotates within the flywheel. The linear reciprocating motion of the piston causes rotation of the flywheel or cylinder by piston pins being pushed down a sloped, spiraling surface of the flywheel, resulting in highly efficient power transfer. The rotational motion is transferred through a final drive, such as a drive shaft, drive train or drive chain. Engines described herein may include pairs of engine modules.

### BACKGROUND

Generally, a four-stroke engine is an internal combustion engine in which a piston completes four separate strokes while turning a crankshaft. Such engines are ubiquitous and have long been known and widely used. In such engines, conversion of chemical energy to mechanical energy occurs through combustion of a fuel in a combustion chamber, causing an increase in pressure that forces the piston downward in the combustion chamber. Most commonly, the piston connecting rod is attached to the piston at one end and offset sections of the crankshaft at the other, and translates the reciprocating motion of the pistons to a circular motion of the crankshaft.

### SUMMARY OF THE INVENTION

An embodiment of the invention may comprise a four-stroke internal combustion engine module comprising: a cylinder having at least on piston pin travel slot; a flywheel rotatably mounted to said cylinder; at least one power stroke track having a sloped and curved power stroke surface disposed within said cylinder; an outer track having at least one sloped compression and exhaust stroke surface and at least one sloped intake stroke surface positioned on a surface of said flywheel; a piston head disposed within said cylinder; at least one piston rod connected to said piston head; and a piston pin connected to each of said at least one piston rod at an end opposite of that connected to said piston head, said piston pin positioned to extend into said at least one piston pin travel slot of said cylinder, a first end of said piston pin remaining within said cylinder that engages said sloped and curved power stroke surface of said at least one power stroke track during a power stroke of said four-stroke engine to rotate said flywheel or said cylinder, and a second end of said piston pin opposite to said first end that engages said at least one sloped compression and exhaust stroke surface and said at least one sloped intake stroke surface of said outer track during compression, exhaust, and intake strokes of said four-stroke engine module to move said piston head during said compression, exhaust, and intake strokes.

Another embodiment of the invention may comprise a four-stroke internal combustion engine comprising at least one four-stroke internal combustion engine module described herein, an engine block, an oil pan, and a final drive.

Another embodiment of the invention may comprise a method of operating a four-stroke internal combustion engine, comprising forcing a piston disposed within a cylinder to create a downward linear movement of said piston during a power stroke, causing a first end of at least one piston pin connected to said piston to engage and move downwardly along a sloped and curved power stroke surface of at least one power stroke track disposed within said cylinder; converting linear movement of said piston into a rotational movement of a flywheel around said cylinder or of said cylinder within said flywheel, wherein the flywheel is rotatably mounted to said cylinder; causing a second end of at least one piston pin connected to said piston to engage at least one sloped compression and exhaust stroke surface disposed on a surface of said flywheel at initiation of said exhaust stroke, causing said second end of at least one piston pin to be pushed up said at least one sloped power surface by said rotational movement of said flywheel or said cylinder and said piston to move upwardly within said cylinder; causing said second end of at least one piston pin to engage at least one sloped intake stroke surface disposed on a surface of said flywheel at initiation of said intake stroke, causing said second of at least one piston pin to be dragged downwardly on said at least one sloped intake surface by the rotational movement of said flywheel or said cylinder and causing said piston to move downwardly within said cylinder; and causing said second end of said at least one piston pin to engage said at least one sloped compression and exhaust stroke surface at initiation of said compression stroke, causing said second end of at least one piston pin to be pushed up said at least one sloped power surface by the rotational movement of said flywheel or said cylinder and causing said piston to move upwardly within said cylinder.

### BRIEF DESCRIPTION OF THE DRAWINGS

FIG. 1 is side view of one embodiment of an engine module 100.

FIG. 2 is a view of an embodiment of a piston 132 that can be employed in the embodiment of FIG. 1.

FIG. 3 is a perspective view of an embodiment of a flywheel 102 that can be employed in the embodiment of FIG. 1, showing the power stroke track 104 and outer track 108.

FIG. 4 is a sectional view of the embodiment of FIG. 1.

FIG. 5 is another sectional view of the embodiment of FIG. 1, showing the piston pins 138 extending through the piston pin travel slots 128 of the cylinder 124 and the power stroke tracks 104 positioned within the cylinder 124. The sectional view plane is not through the center of engine module 100.

FIG. 6 is another sectional view of the embodiment of FIG. 1. The cut-away view plane is not through the center of engine module 100.

FIG. 7 is a sectional view of the embodiment of FIG. 6, providing another view of the power stroke track 104 and outer track 108. The sectional view plane is not through the center of flywheel 102.

FIG. 8 is a sectional view of the embodiment of FIG. 6, providing yet another view of the power stroke track 104 and outer track 108. The sectional view plane is through the center of flywheel 102.

FIG. 9 is a sectional view of flywheel 102 and piston 132, showing the position of the piston 132 within the flywheel 102 as the piston approaches bottom dead center of the power stroke, with the piston pins 138 engaging the power stroke surface 106 of the power stroke track 104 in the embodiment of FIG. 1.

FIG. 10 is a sectional view of flywheel 102 and piston 132, showing the position of the piston 132 within the flywheel 102 during either the compression or exhaust stroke, with the piston pins 138 engaging the compression and exhaust stroke surface of the outer track 108 in the embodiment of FIG. 1.

FIG. 11 is a sectional view of flywheel 102 and piston 132, showing the position of the piston 132 within the flywheel 102 at top dead center in the embodiment of FIG. 1.

FIG. 12 is a sectional view of flywheel 102 and piston 132, showing the position of the piston 132 within the flywheel 102 early during the intake stroke, with the piston pins 138 engaging the intake stroke surface 112 of the outer track 108 in the embodiment of FIG. 1.

FIG. 13 is a view of one embodiment of an engine configuration having two horizontally opposed engine modules of FIG. 1.

FIG. 14 is a view of the embodiment of FIG. 13 with the addition of the engine block 164 and oil pan 162.

FIG. 15 is an illustration representing the slope of a compression and exhaust stroke surface 110. Piston pin 138 and its direction of travel along compression and exhaust stroke surface 112 during operation of the embodiment of FIG. 1 are shown.

FIG. 16 is an illustration representing the slope of an intake stroke surface 112. Piston pin 138 and its direction of travel along intake stroke surface 112 during operation of the embodiment of FIG. 1 are shown.

FIG. 17 is an illustration representing the slope of a power track 104 having a less aggressive (shallower) slope towards the top of the track than towards the bottom. Vector Pₜₒₚ represents the downward force of a piston 132 as it engages power stroke track 104 near the top of the track. Vector Fₜₒₚ represents the force exerted on power stroke track 104, and thus flywheel 102, as piston 132 engages power stroke track 104 near the top of the track. Vector P_{bottom} represents the downward force of a piston 132 as it engages power stroke track 104 near the bottom of the track. Vector F_{bottom} represents the force exerted on power stroke track 104, and thus flywheel 102, as piston 132 engages power stroke track 104 near the bottom of the track.

FIG. 18 is an illustration representing the slope of a power track 104 having a more aggressive (steeper) slope towards the top of the track than towards the bottom. Vector Pₜₒₚ represents the downward force of a piston 132 as it engages power stroke track 104 near the top of the track. Vector Fₜₒₚ represents the force exerted on power stroke track 104, and thus flywheel 102, as piston 132 engages power stroke track 104 near the top of the track. Vector P_{bottom} represents the downward force of a piston 132 as it engages power stroke track 104 near the bottom of the track. Vector F_{bottom} represents the force exerted on power stroke track 104, and thus flywheel 102, as piston 132 engages power stroke track 104 near the bottom of the track.

FIG. 19 is a vector diagram of a standard piston-crankshaft arrangement in an internal combustion engine with the piston at top dead center. Arrow A indicates the piston movement within the cylinder. Arrow B indicates the rotational movement of the crankshaft. Arrow C indicates the approximate force of the piston rod on the crankshaft.

FIG. 20 is a vector diagram of a standard piston-crankshaft arrangement in an internal combustion engine with the piston just past top dead center. Arrow A indicates the piston movement within the cylinder. Arrow B indicates the rotational movement of the crankshaft. Arrow C indicates the approximate force of the piston rod on the crankshaft.

FIG. 21 is a vector diagram of a standard piston-crankshaft arrangement in an internal combustion engine with the piston approximately halfway between top dead center and bottom dead center. Arrow A indicates the piston movement within the cylinder. Arrow B indicates the rotational movement of the crankshaft. Arrow C indicates the approximate force of the piston rod on the crankshaft.

FIG. 22 is vector diagram of the embodiment of FIG. 1. Arrow A indicates the linear movement of the piston rod 136 and the piston rod pin 138. Arrow B indicates the rotational movement of the flywheel 102. Arrow C indicates the approximate force of the piston pin 138 on the power stroke surface 106.

### DETAILED DESCRIPTION

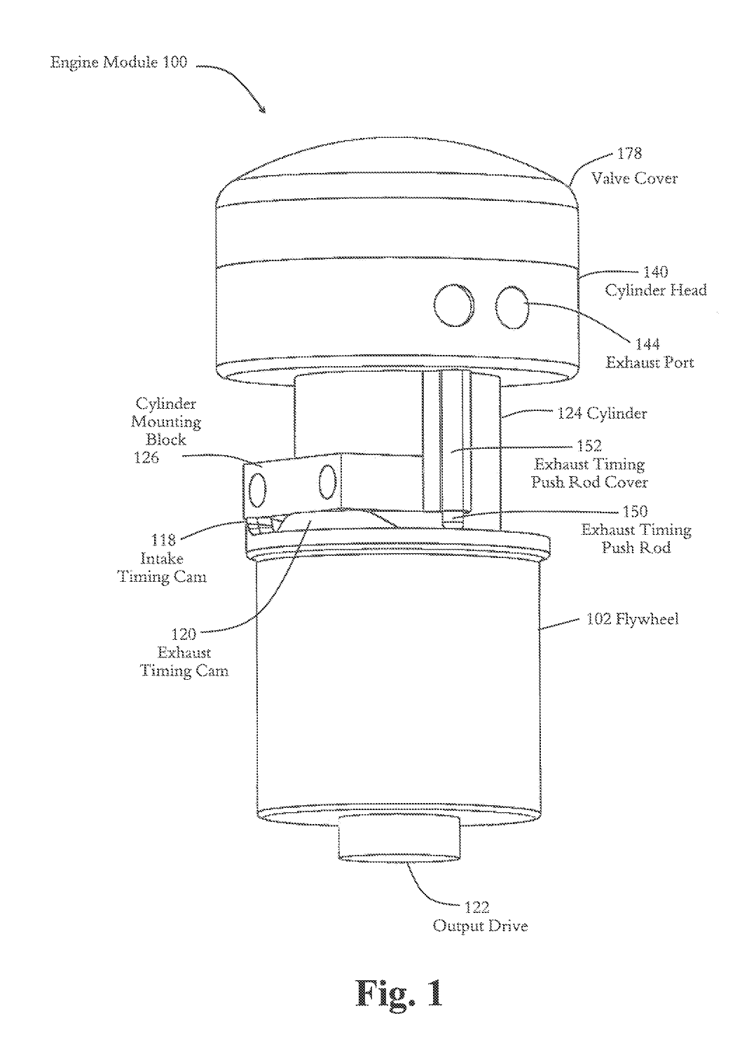

FIG. 1 is a side view of an embodiment of four-stroke internal combustion engine module 100. Engine module 100 includes flywheel 102, which is rotatably mounted to stationary cylinder 124. Flywheel 102 has intake timing cam 118 and exhaust timing cam 120, and output drive 122. Cylinder mounting block 126 is connected to cylinder 124 and provides for the rigid mounting of the cylinder 124. Thus engine module 100 can be mounted to a mounting surface (not shown) to hold the cylinder 124 stationary. Engine module 100 further includes cylinder head 140, which has exhaust ports 144. The cylinder 124 and cylinder head 140 can be constructed as one solid piece, or in two piece that may be connected together. A valve cover 178 is attached to cylinder head 140. Exhaust timing push rod 150 is mounted within cylinder head 140 and is adapted to engage the exhaust timing cam 120 as the flywheel 102 rotates around the axis of cylinder 140s. Exhaust timing push rod cover 152 is mounted to the side of cylinder 124 and is adapted to cover and protect exhaust timing push rod 150.

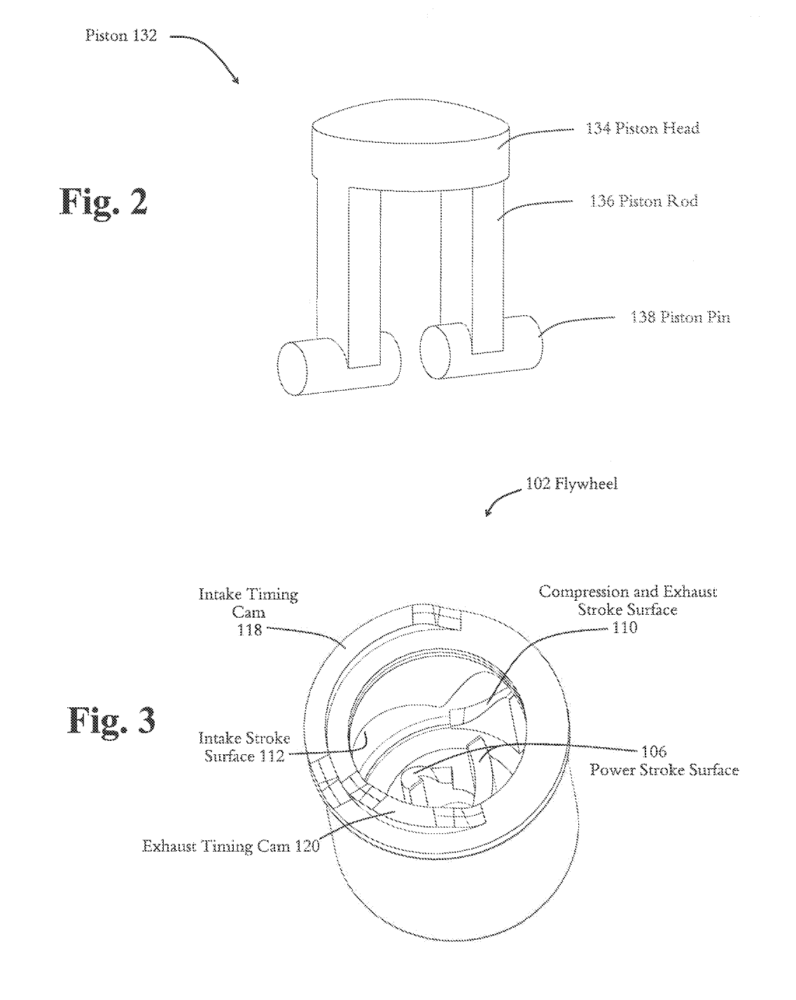

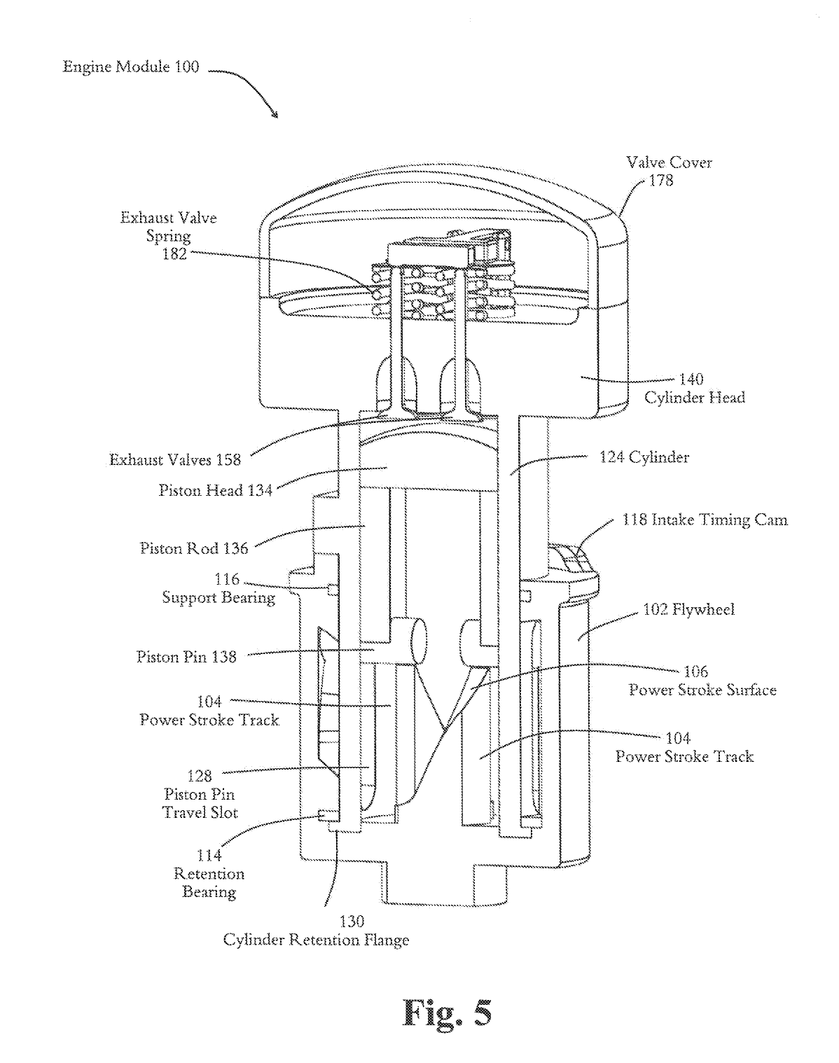

FIG. 2 is a view of an embodiment of a piston 132 that can be employed in the embodiment of the engine module 100 of FIGS. 1 and 4-6. Piston 132 includes piston head 134, piston rods 136, and piston pins 138. Bearings can be mounted on the length of a piston pin 138 that extends through cylinder 124 via piston pin travel slot 128 (see, e.g., FIG. 5). The bearings function to reduce friction between piston pins 138 and the wall of the cylinder 124 as piston pins 138 travel within piston pin travel slots 128. Bearings can also be provided on ends of piston pins 138 that engage with surfaces of power stroke track 104 or outer track 108 of flywheel 102 (see FIGS. 3-12).

FIG. 3 is a perspective view of an embodiment of a flywheel 102 that can be employed in the embodiment of the engine module 100 depicted in FIGS. 1 and 4-6. Flywheel 102 includes power stroke surfaces 106, compression and exhaust stroke surface 110, intake stroke surface 112, intake timing cam 118, and exhaust timing cam 120. Power stroke surfaces 106 are disposed on power stroke tracks 104, as shown in, for example, FIG. 5. Power stroke surfaces 106 are positioned within flywheel 102 so that when flywheel 102 is rotatably mounted to cylinder 124, the power stroke surfaces are located within cylinder 1124. Power stroke tracks 104, and thus power stroke surfaces 106, are both sloped and curved, and are adapted to transfer linear reciprocating movement of piston 122 into rotational movement of flywheel 102 during the power stroke of four-stroke engine module 100. Outer track 108 includes compression and exhaust stroke surface 110 and intake stroke surface 112. Compression and exhaust stroke surface 110 is disposed on an inner surface of flywheel 102. Compression and exhaust stroke surface 110 is sloped and follows the curvature of the inner surface of flywheel 102. The compression and exhaust stroke surface 110 is adapted to move piston 132 from bottom dead center to top dead center during either the compression or exhaust strokes of four-stroke engine module 100. The compression and exhaust stroke surface 110 can either be a singular surface on which a piston pin 138 can travel or a “track” in which a piston pin 138 can travel. Intake stroke surface 112 is disposed on an inner surface of flywheel 102, is sloped, and follows the curvature of the inner surface of flywheel 102. The intake stroke surface is adapted to move piston 122 from top dead center to bottom dead center during the intake stroke during the intake stroke of four-stroke engine module 100, and to allow piston pin 138 to engage power stroke surface 106 during the power stroke. A flywheel including power stroke tracks 104 having power stroke surfaces 106, compression and exhaust stroke surfaces 110, intake stroke surface 112, intake timing cam 118, and exhaust timing cam can be manufactured as a single article. Alternately, one or more of the surfaces or cams can be manufactured separately from flywheel 102 and attached to flywheel 102, resulting in a multi-piece flywheel.

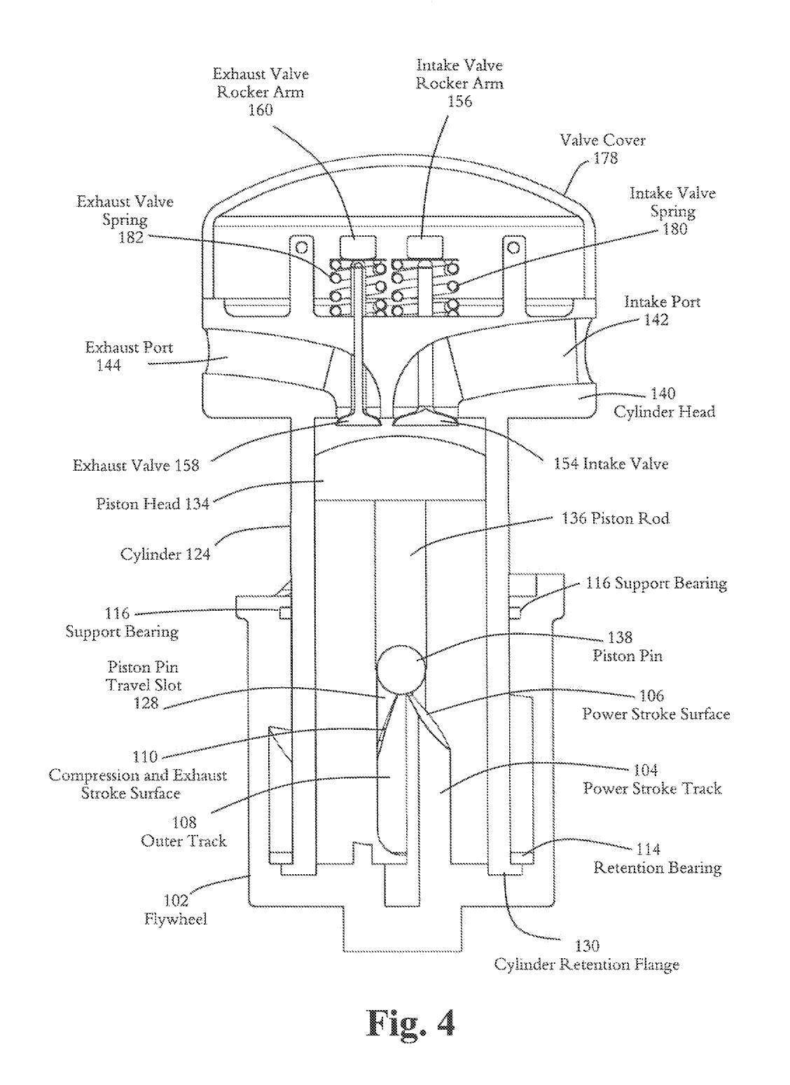

FIG. 4 is a sectional view of the embodiment of the engine module 100 of FIG. 1. As illustrated in FIG. 4, flywheel 102 includes power stroke track 104 having a sloped and curved power stroke surface 106 positioned within cylinder 124. Outer track 108, having sloped compression and exhaust stroke surface 110, is disposed on the inner surface of flywheel 102, and positioned outside of cylinder 124. Cylinder 124 includes piston pin travel slot 128 and cylinder retention flange 130. Flywheel 102 is rotatably mounted to cylinder 124 by cylinder retention bearing 114, which overlaps and engages cylinder retention flange 130. Retention bearing 114 is chosen and adapted to have good load bearing capacity and maintain a rotatable relationship between flywheel 102 and stationary cylinder 124. Support bearing 116 separates the wall of cylinder 124 from the flywheel 102 while allowing for the rotation of flywheel 102 around the cylinder 124 with minimal friction, and adds stability to the flywheel 102/cylinder 124 relationship. Examples of bearings useful as either the retention bearing 114 or support bearing 116 include plain bearings, ball bearings, roller bearings, tapered roller bearings, needle roller bearings, fluid bearings, and thrust bearings. Disposed within cylinder 124 is a piston 122 having a piston head 134, piston rod 136, and piston pin 138. Piston pin 138 extends through piston travel slot 128, allowing an end of piston pin 138 to extend out of the cylinder 124 and engage surfaces of the outer track 108 during intake, compression, and exhaust strokes. The end of the piston pin 138 that remains within the cylinder engages power stroke surface 106 of power stroke track 108 as the piston moves downward within the cylinder during the power stroke. Cylinder head 140 includes intake port 142, exhaust port 144, intake valve 154, intake valve spring 180, intake valve rocker arm 156, exhaust valve 158, exhaust valve spring 182, and exhaust valve rocker arm 160. Intake valve 154 is adapted to control air and fuel entry into cylinder 124 through intake port 142. Intake valve rocker arm 156 engages intake valve 154 and opens the valve by pushing down on intake valve 154. Intake valve 154 is returned to a closed position by intake valve spring 180. Exhaust valve 158 is adapted to control dissipation of exhaust gases from cylinder 124 through exhaust port 144 following combustion. Exhaust valve rocker arm 160 engages exhaust valve 158 and opens the valve by pushing down on exhaust valve 158. Intake valve 158 is returned to a closed position by exhaust valve spring 182. Valve cover 178 is attached to cylinder head 140 to cover intake valve 154, intake valve spring 180, intake valve rocker arm 156, exhaust valve 158, exhaust valve spring 182, and exhaust valve rocker arm 160.

FIG. 5 is another sectional view of the embodiment of the engine module 100 of FIG. 1, shown on a different sectional plane that that shown in FIG. 4. As illustrated in FIG. 5, flywheel 102 has two power stroke tracks 104 positioned within the cylinder, cylinder 124 has two piston pin travel slots 128 positioned opposite one another, and the piston includes two piston rods 136, each piston rod being connected to a piston 138. An end of each piston pin 138 extends through a piston pin travel slot 128 in cylinder 124. As described above, the end of each piston pin 138 that extends through the cylinder 124 can engage surfaces of the outer track 108 during intake, compression, and exhaust strokes, while the end of each piston pin 138 that remains within the cylinder can engage power stroke surface 106 of one of the power stroke tracks 108 within cylinder 124 as the piston moves downward within the cylinder 124 during the power stroke.

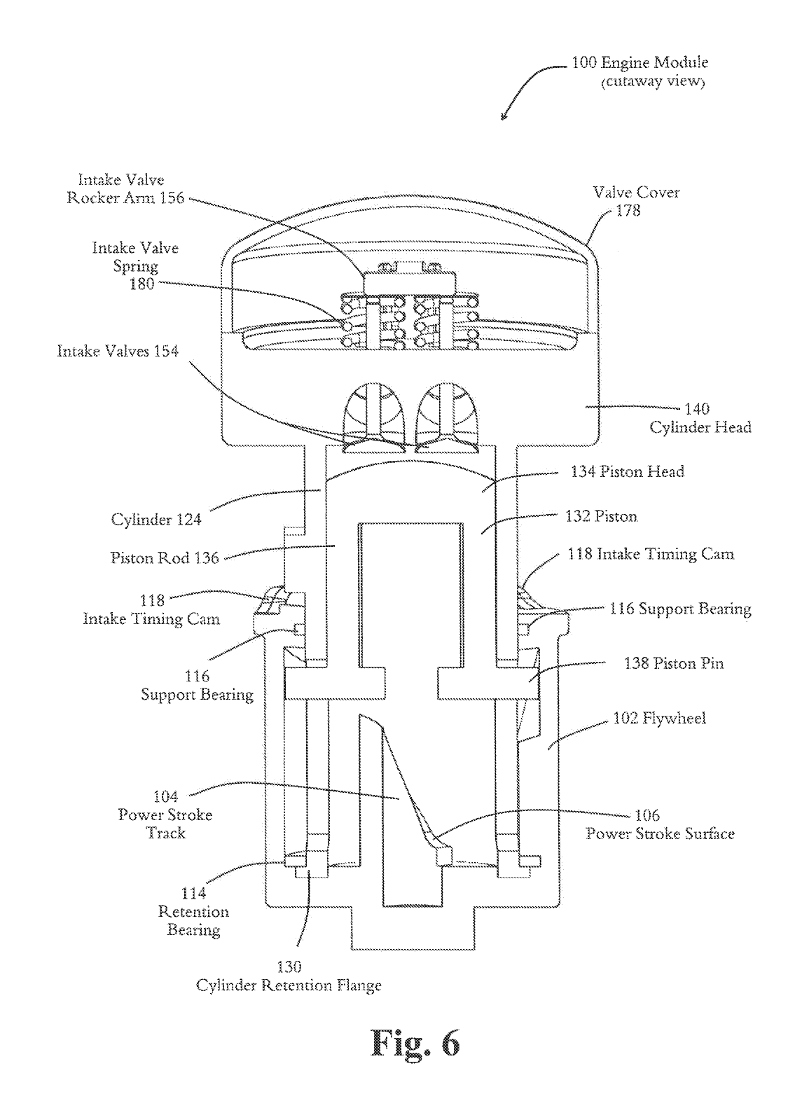

FIG. 6 is yet another sectional view of the embodiment of the engine module 100 of FIG. 1, shown on a different sectional plane that that shown in FIGS. 4 and 5. FIG. 4 illustrates piston pins 138 extending through cylinder 124.

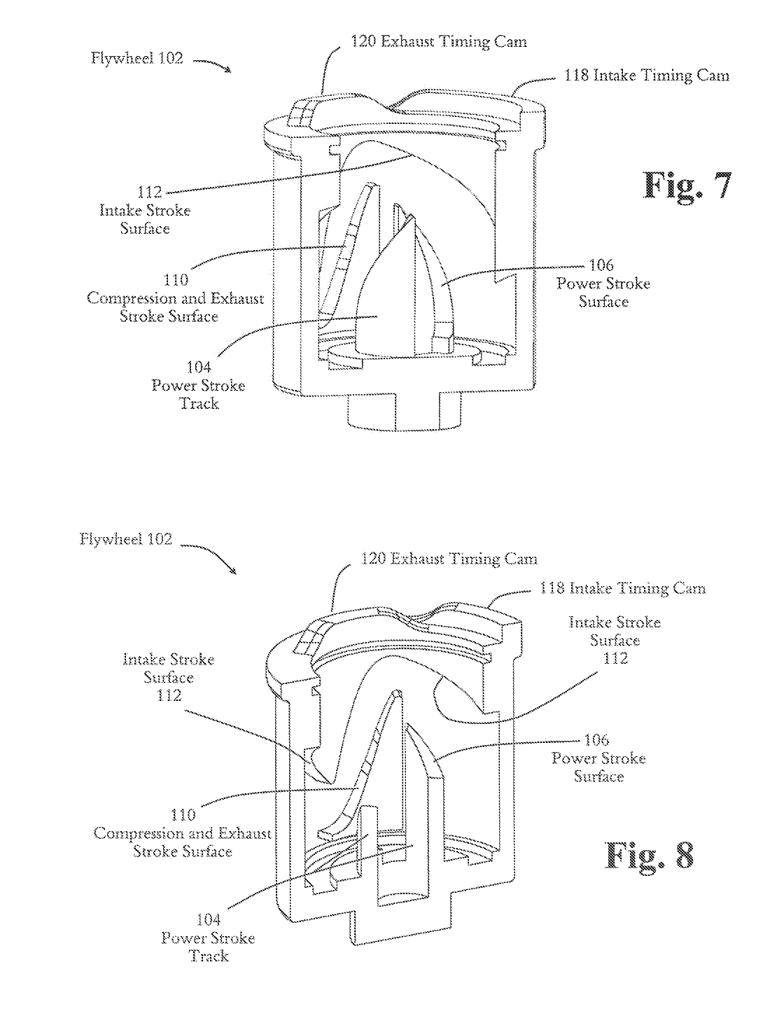

FIG. 7 is a sectional view of the embodiment of the flywheel 102 depicted in FIG. 6. FIG. 7 provides another view of power stroke tracks 104, each having a power stroke surface 106, and the compression and exhaust stroke surface 110 and intake stroke surface 112. FIG. 7 illustrates the slope and curvature of the power stroke tracks 104.

FIG. 8 is another sectional view of the embodiment of the flywheel 102 depicted in FIG. 6. FIG. 8 provides an unobstructed view of compression and exhaust stroke 110. The visible channel in the floor of flywheel 102 provides space for cylinder retention flange, allowing mounting of flywheel 102 to cylinder 124 using retention bearing 114.

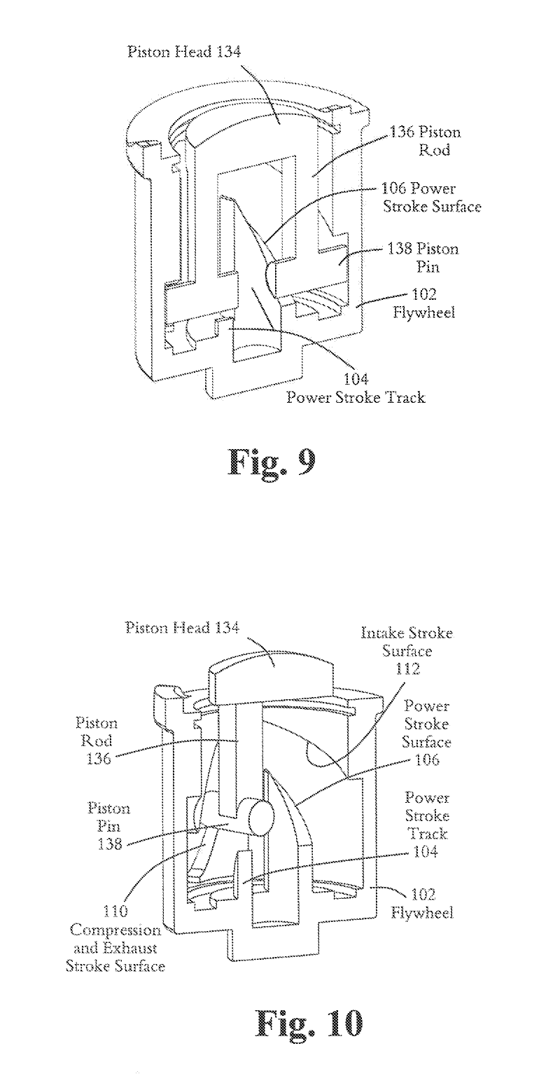

FIGS. 9-12 are sectional views of the position of piston 132 within flywheel 102 through the four cycles of the embodiment of the engine module 100 of FIG. 1. The cylinder 124 has been omitted from these figures for ease of visualization.

FIG. 9 depicts the end of piston pins 138 that remain within cylinder 124 of piston 132 engaging the power stroke surface 106 of power stroke tracks 104 as piston 132 approaches bottom dead center. Piston pins 138 first engage the power stroke surface 106 of power stroke tracks during combustion. Combustion forces piston 132, and thus piston pins 138, downward. The arrangement of intake stroke surface 112 allows piston pins 138 to be forced downward onto the power stroke surface of power stroke tracks 104. As piston 132 is forced toward bottom dead center during the power stroke, piston pins 138 are forced downward along the power stroke surface 106 of the sloped, curved power stroke tracks 104. The result is the conversion of linear motion of piston 132 into rotational motion of the flywheel 102 at a 90 degree angle relative to the axis of the cylinder 124. Piston pin travel slots 128 of cylinder 124 (not shown) stabilize piston 132 within cylinder 124, preventing it from spinning within the cylinder 124.

FIG. 10 depicts the end of piston pin 138 that extends out of cylinder 124 through piston pin travel slot 128 of cylinder 124 engaging the compression and exhaust stroke surface 110 as piston 132 moves towards top dead center. Piston pin 138 first engages the compression and exhaust stroke surface 110 at the initiation of either the compression stroke or the exhaust stroke, when piston 132 is at bottom dead center. To initiate the exhaust stroke, the rotational movement of flywheel 102 resulting from the power stroke causes piston pin 138 to transfer from power stroke surface 106 to compression and exhaust stroke surface 110 at the end of the power stroke. As flywheel 102 rotates around stationary cylinder 124, flywheel 102 acts on piston 132, pushing it towards top dead center as the piston pin 138 moves upward along the sloped compression and exhaust stroke surface 110. To initiate the compression stroke, the rotational movement of flywheel 102 resulting from the power stroke causes piston pin 138 to transfer from intake stroke surface 106 to compression and exhaust stroke surface 110 at the end of the intake stroke. Similarly to the exhaust stroke, as flywheel 102 rotates around stationary cylinder 124, flywheel 102 acts on piston 132, pushing it towards top dead center as the piston pin 138 moves upward along the sloped compression and exhaust stroke surface 110.

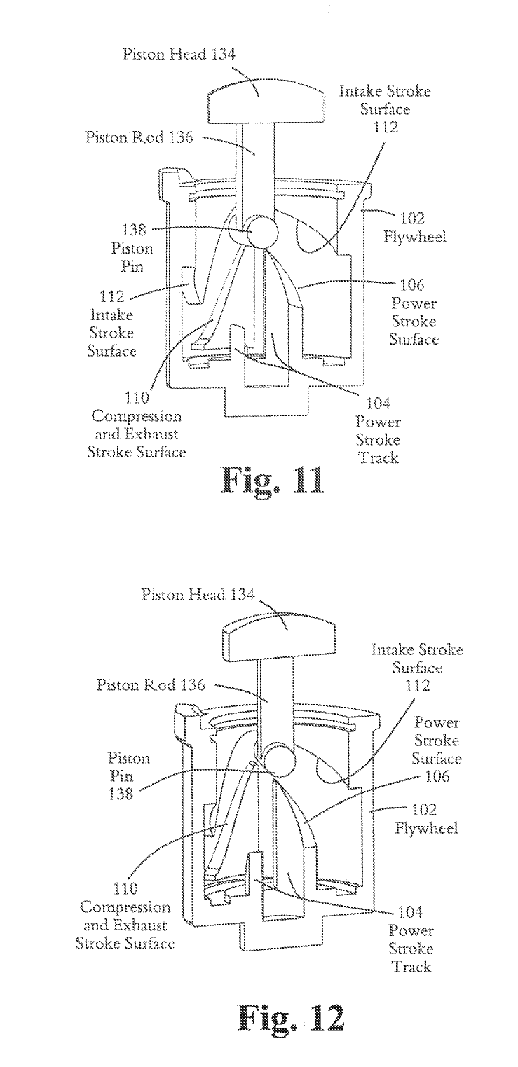

FIG. 11 depicts piston pin 138 about to disengage from compression and exhaust stroke surface 110, very near top dead center. From this position, piston pin 138 transfers to power stroke surface 106 following the compression stroke, or to intake stroke surface 112 following the exhaust stroke. A small amount of free play between the piston pins 138 and the stroke surfaces allow for the piston pins 138 to transition from one surface to another.

FIG. 12 depicts the end of piston pin 138 that extends out of cylinder 124 through piston pin travel slot 128 of cylinder 124 engaging intake stroke surface 112 at the beginning of the intake stroke, when piston 132 is near top dead center. Piston pin 138 first engages the intake stroke surface 112 at the initiation of the intake stroke, when piston 132 is at top dead center. To initiate the intake stroke, the rotational movement of flywheel 102 resulting from the power stroke causes piston pin 138 to transfer from compression and exhaust stroke surface 110 to intake stroke surface 112 at the end of the exhaust stroke. As flywheel 102 rotates around stationary cylinder 124, flywheel 102 acts on piston 132, dragging it towards bottom dead center as piston pin 138 moves downward along the sloped intake stroke surface 110.

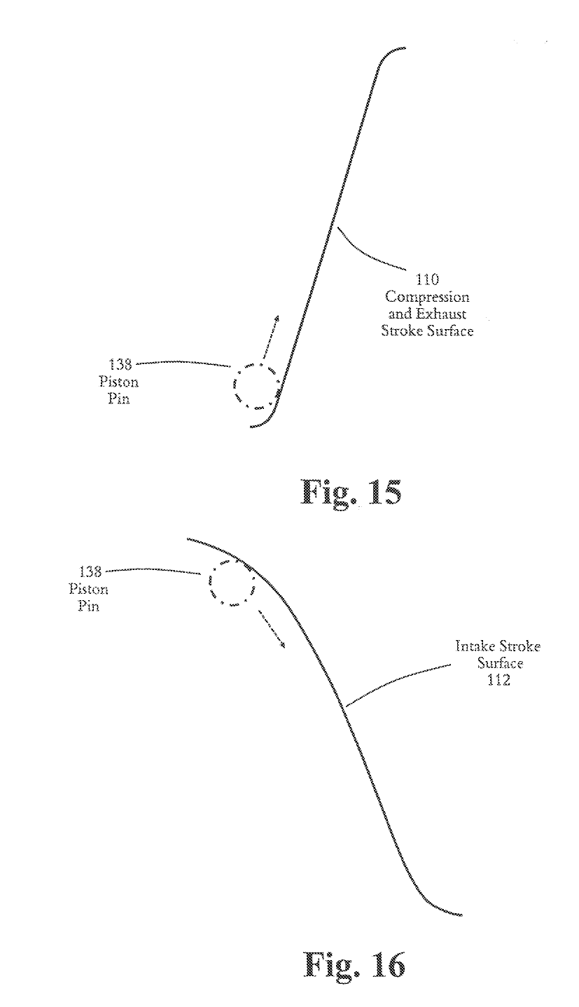

To summarize the movement of piston 132 through the four strokes of four-stroke engine module 100 as depicted in FIGS. 9-12, upon combustion during the power stroke, piston pins 138 are forced downward along the power stroke surface 106 of power stroke tracks 104 as piston 132 moves from top dead center toward bottom dead center. This results in the conversion of the linear movement of piston 132 within cylinder 124 into rotational movement of flywheel 102. The rotational movement of flywheel 102 the moves piston 132 through exhaust, intake, and compression strokes, where flywheel 102 acts on piston 132. Piston 132 is pushed upward from bottom dead center toward top dead center during compression and exhaust strokes as piston pins 138 move upward along compression and exhaust stroke surface 110 (see FIG. 15). Piston is dragged downward from top dead center toward bottom dead center during the intake stroke as piston pins move downward along intake stroke surface 112 (see FIG. 16).

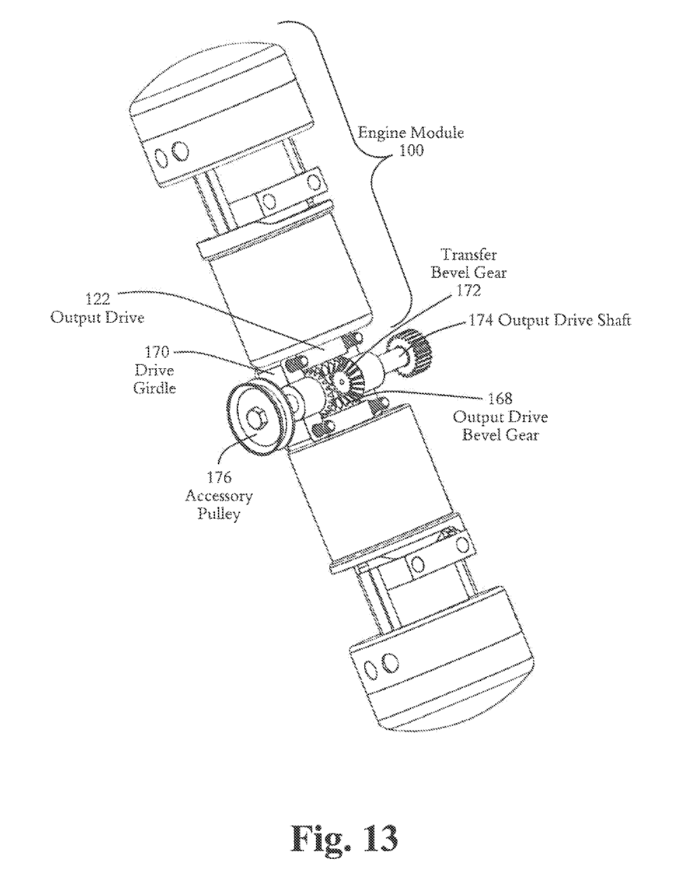

FIG. 13 a view of one embodiment of an engine configuration having two horizontally opposed engine modules 100 of FIG. 1. The engine includes two horizontally opposed engine modules 100, where output drive bevel gears 168 are connected to output drives 122 of engine modules 100. Output drive bevel gears 168 engages transfer bevel gears 172. Transfer bevel gears 172 are connected to output drive shaft 174 or accessory pulley 176. The two horizontally opposed engine modules 100, along with transfer bevel gears 172, output drive shaft 174, and accessory pulley 176 are held in place by drive girdle 170. In the engine configuration depicted in FIG. 13, reciprocating linear motion of a piston in engine modules 100 is converted to rotational motion of flywheel 102, which is in turn transferred to output drive shaft 174 and accessory pulley 176. The output drive shaft 174 can be, for example, adapted to power a motor vehicle, while the accessory pulley can be adapted to power common motor vehicle accessories (e.g., air conditioner, alternator, power steering, water pump, etc.). Of course, the engine depicted in FIG. 13 can be modified and adapted to use other drive means in place of a drive shaft, such as, for example, a drive chain or a drive belt.

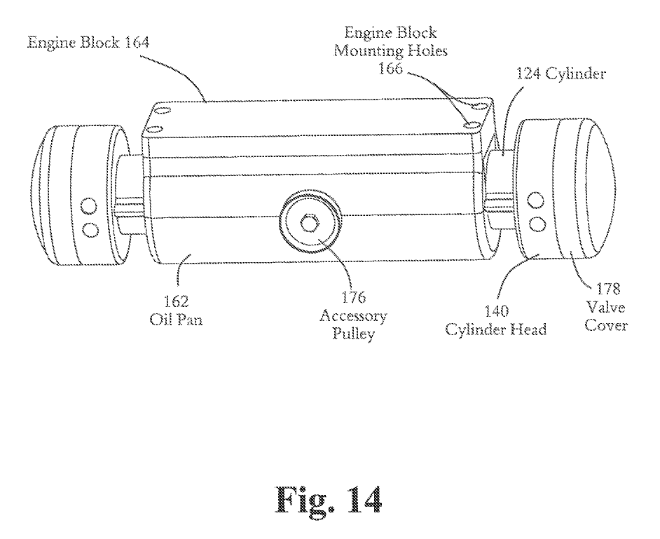

FIG. 14 is a view of the engine embodiment of FIG. 13, with the addition of engine block 164 and oil pan 162. Engine block 164 includes engine block mounting holes 166. Engine module 100 can be rigidly mounted to a mounting surface by way of cylinder mounting block 126 (FIG. 1) using bolts passing through engine block mounting holes 166. This mounting configuration results in a stationary cylinder 124 around which a flywheel 102 can rotate. The mounting surface can be, for example, mounting brackets of a motor vehicle. In one embodiment, the engine module 100 housed within the engine block 164 and oil pan 166 is mounted beneath the mounting surface. Cylinder 124, cylinder head 140, and valve cover 178 of engine module 100 are visible in FIG. 14. As illustrated in FIG. 14, engine module 100 is held horizontally between engine block 164 and oil pan 162. This configuration allows the flywheel 102 to be in constant contact with oil, keeping flywheel 102 and engine module 102 lubricated.

As described herein, linear reciprocating motion of piston 132 of four-stroke engine module 100 is converted into rotational motion of the flywheel 102 by the power stroke track during combustion of the power stroke. Rotational motion of the flywheel 102 is then converted to linear reciprocation motion of the piston 132 during the intake, compression, and exhaust cycles. Conversion of linear reciprocating motion to rotational motion is accomplished during the combustion stroke when the piston pins 138 are forced down the declining, curved slopes of the power stroke tracks 104. As the piston pins are forced down the power stroke tracks 104, the linear reciprocating motion of the piston 132 is converted into rotational motion of the flywheel 102 at a 90 degree angle relative to the axis of the cylinder 124. The rotating flywheel then transfers the converted rotational motion through output drive 122 to a final drive.

The slopes of the surfaces of the power stroke track 104 and outer track 108 can be optimized for any particular application. Considerations in selecting the slopes for the power stroke track 104 and outer track 108 include, for example, internal engine stress, stress on the piston 132 and in particular, piston pins 138, internal friction, desired power transfer efficiency, desired flywheel 102 rotation per stroke, and cycle/engine timing.

FIGS. 15-16 are representative illustrations of compression and exhaust stroke surface 110 and intake stroke surface 112, respectively, of outer track 108. The slopes of the outer track 108 can be selected to reduce internal stress and friction by having less aggressive (shallower) slopes, while a more aggressive (steeper) overall slope on the power stroke track 104 provides for better overall power transfer. A more aggressively sloped compression and exhaust stroke surface 110 of the outer track 108 increases friction between the compression and exhaust stroke surface 110 of the outer track 108 and piston pins 132 as the compression and exhaust stroke surface 110 returns the piston 132 to top dead center. A more aggressively sloped compression and exhaust stroke surface 110 will also result in a shorter compression and exhaust strokes spanning fewer degrees of rotation of the flywheel 102. This in turn allows for more rotation of the flywheel 102 during the power stroke, and more time for intake during the intake stroke. By shortening the compression and exhaust strokes, compression retention is improved and thermal loss is minimized. These benefits must be balanced with the increased friction and internal stress resulting from a more aggressively sloped compression and exhaust stroke surface.

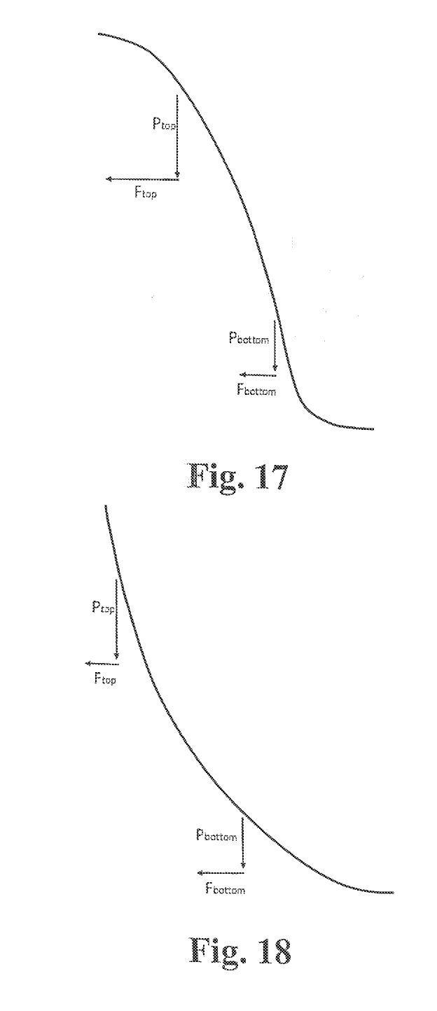

In a particular embodiment, the slope of the power stroke track 104 is less aggressive towards the top of the track than towards the bottom of the track. This is illustrated in FIG. 17, which depicts such a slope. The piston pins 138 interact with the power stroke track 104 towards the top of the track when the piston 132 is at top dead center, where maximum linear force is available from piston 132. This results in greater force being exerted on flywheel 102 at a 90 degree angle relative to the path of the piston, causing flywheel 102 to rotate, as illustrated by arrow Fₜₒₚ of FIG. 17. A more aggressive slope toward the top of the power stroke track 104 results is less rotational force being exerted on the flywheel 102, as illustrated by arrow Fₜₒₚ of FIG. 18, which shows a more aggressive slope toward the top of the track. A less aggressive slope towards the top of the track provides for more rotation of the flywheel 102, while the more aggressive slope towards the bottom of the power stroke track 104 allows the piston 132 to move downward more easily as it loses force during the power stroke (arrow P_{bottom}, FIG. 17), efficiently transferring available force from piston 132 to flywheel 102 (arrow F_{bottom}, FIG. 18) as the piston 132 is forced towards bottom dead center.

In certain embodiments, the slope of the intake stroke surface 112 is selected to drag piston 132 from top dead center to bottom dead center over the same angular displacement that the flywheel 102 undergoes during the power stroke. For example, if the power stroke results in an angular displacement of the flywheel 102 of 120°, the slope of the intake stroke surface is such that the piston is dragged from top dead center to bottom dead center by the flywheel 102 rotating 120°.

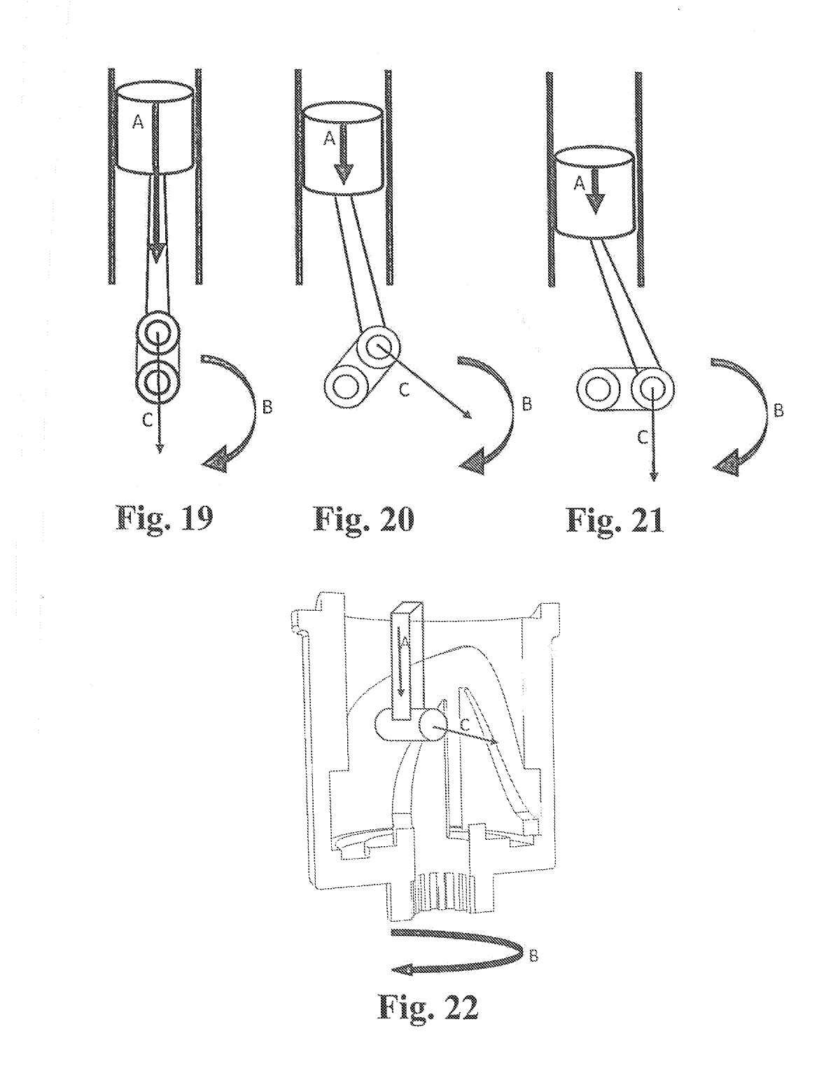

The rotating flywheel arrangement of the internal combustion engine module described herein is advantageous relative to the piston-crankshaft arrangement of a standard internal combustion engine. In a standard piston-crankshaft arrangement, maximum downward force from combustion occurs when the piston is at or near top dead center, with the piston rod being vertical or nearly vertical (i.e., piston rod at or near 0 degrees relative to the crankshaft). FIGS. 19-22 are vector diagrams showing a standard piston-crankshaft arrangement, where arrow A represents the movement of the piston, arrow B represents the direction of rotation of the crankshaft, and arrow C represents the approximate direction of force exerted by the piston rod on the crankshaft. As shown in FIGS. 19-20, in such a configuration, the downward force caused by combustion must be transferred, at least for several degrees of rotation of the crankshaft, through the vertical or nearly vertical piston rod. However, the most efficient mechanical use of combustion force will occur when the connecting rod and crankshaft are at right angles, as shown in FIG. 21, a position at which the downward force of the piston has already been at least partially lost. This configuration also results in a side thrust by the piston on the cylinder wall. With the arrangement of the internal combustion engine described herein and shown in FIG. 20, the downward, linear force of the piston 132 (FIG. 22, arrow A) caused by combustion is immediately transferred into rotational movement of the flywheel 102 (FIG. 22, arrow B) at a 90 degree angle relative to the piston's 132 linear travel. Arrow C of FIG. 22 shows the approximate directional force exerted by the piston pin 138 on the power stroke track 104. Efficient energy transfer thus begins early during the combustion stroke, when downward force from the piston 132 is at its maximum. Further, where the slope of the power stroke surface 106 is more aggressive towards the bottom of the power stroke track, the remaining energy of the piston 132 is efficiently transferred to the power stroke track 104 and the flywheel 102 as the piston 132 approaches bottom dead center. The arrangement of the internal combustion engine described herein also reduces the side thrust by the piston 132 on the cylinder 124 relative to the standard piston-crankshaft arrangement.

The diameter of the flywheel 102 can also be optimized for any particular application. A flywheel 102 having a larger diameter allows the surfaces of the outer track 110 of the flywheel to be sloped less aggressively while providing for the same angular displacement relative to a flywheel 102 having a smaller diameter. As described above, compression and exhaust stroke surfaces 110 and intake stroke surfaces 112 having less aggressive slopes results in reduced friction and internal stress. Because of this, an engine module 100 comprising a flywheel 102 having a large diameter will be more efficient compared to an engine module 100 having a smaller diameter. The relative diameter of the power stroke track 104 does not need to increase proportionally with the diameter of the flywheel 102. Having a power stroke track 104 with a smaller diameter and more aggressively sloped power stroke surface 106 provides for a greater angular displacement by the flywheel 102. However, when selecting the diameter of the power stroke track 104, the stress placed on both the power stroke track 104 and piston pins 132 must be taken into consideration. With a smaller diameter, the power stroke track 104 will have a decreased load bearing capacity relative to a power stroke track 104 having a larger diameter. Where the diameter of the power stroke track 104 is small relative to the diameter of the flywheel 102, the piston pins will need to be longer in order to extend through the cylinder 124 via the piston pin travel slots 128 and reach the power stroke surface 106 of the power stroke track 104. This added length will place additional stress on the piston pins 138.

The timing of the various strokes is generally determined by slopes of the surfaces of the power stroke track 106 and the outer track 108. Referring to the outer track 106, a more aggressive slope will result in a shorter stroke duration and a smaller angular displacement. The power stroke track 104 provides for the majority of the angular displacement of the flywheel 102, and as described above, the slope of the power stroke surface can vary from less to more aggressive from the top to the bottom of the power stroke track 104 to take advantage of maximal power from the piston 132 being available at top dead center. In a preferred embodiment, of 360° of a full rotation of the flywheel 102, compression and exhaust strokes account for a smaller angular displacement than the intake and power strokes. This arrangement allows more time for intake and more rotation out of the power stroke. In such an arrangement, the compression and exhaust strokes are performed quickly, providing for better compression retention and less thermal loss.

Control of timing can occur through use of intake timing cam 118, intake timing push rod 146, exhaust timing cam 120, and exhaust timing push rod 150. The timing push rods are mounted and positioned to interact with the timing cams as the flywheel 102 rotates around the cylinder 124. The timing push rods act on intake valves 154 and exhaust valves 158 through intake valve rocker arm 156 and exhaust valve rocker arm 160. As the flywheel 102 rotates around cylinder 124, the intake timing push rod 146 is pushed up by the intake timing cam 118, which in turn causes the intake valves 154 to open during the intake stroke, i.e., as the flywheel drags piston 132 from top dead center towards bottom dead center through the interaction between the piston pins 138 and the intake stroke surface 112. The compression and power strokes then proceed as described above. Following the completion of the power stroke, the exhaust timing push rod 152 is push up by the exhaust timing cam 120, which in turn causes the exhaust valves 158 to open during the exhaust stroke, i.e., as the flywheel pushes piston 132 from bottom dead center towards top dead center, forcing the expulsion of exhaust gases from the cylinder. The cycle then repeats as the intake timing push rod 146 is pushed up by the intake timing cam 118. The intake timing cam 118 and exhaust timing cam 120 are configured to cause valve opening for the duration of either the intake or exhaust cycles, and are therefore related to the slopes of the intake stroke surface 112 and the compression and exhaust stroke surface 110. In certain embodiments, the timing can be controlled electronically, obviating the need for intake timing cam 118, intake timing push rod 146, exhaust timing cam 120, and exhaust timing push rod 150.

In another embodiment, it is the flywheel 102 that is rigidly mounted to a mounting surface, thus remaining stationary. Where the flywheel 102 is rigidly mounted to the mounting surface, the cylinder 124 rotates within the flywheel 102. In such a configuration, the flywheel 102 may still be considered to be rotatably mounted to the cylinder 124. The piston pins 138 interact with power stroke track 104, compression and exhaust stroke surface 110, and intake stroke surface 112 as described above during intake, compression, power, and exhaust strokes. Similarly to the embodiment described above, linear movement of the piston within the cylinder is converted to rotational movement during the power stroke. As piston 132 is forced toward bottom dead center during the power stroke, piston pins 138 are forced downward along the power stroke surface 106 of the sloped, curved power stroke tracks 104. As the piston pins 138 are forced downward along the sloped, curved power stroke tracks 104, the piston pins 138 cause the rotation of the cylinder 124 by exerting force on piston pin travel slots 128. Unlike where the cylinder 124 is rigidly mounted and the piston 132 remains stationary, when the flywheel 102 is rigidly mounted and the cylinder 124 rotates within the flywheel 102, the piston 132 will rotate along with the cylinder 124.

Where the cylinder 124 rotates within the flywheel 102, cylinder head 140 may be omitted and replaced by a port system distal to the flywheel. In such an embodiment, the cylinder 124 comprises an intake and exhaust port positioned distally relative to the flywheel. As the cylinder rotates within the flywheel, the intake and exhaust port interacts with either an intake source capable of introducing fuel and air into the cylinder via the intake and exhaust port during the intake cycle, or an exhaust outlet capable of receiving exhaust gasses from the cylinder via the intake and exhaust port during the exhaust cycle.

An engine module 100 can be mounted in any orientation, including horizontally, vertically, or at any angle. In a particular embodiment, the engine module 100 is mounted horizontally, as shown in FIG. 14. Where the engine module 100 is mounted horizontally, the engine is mounted directly beneath the mounting surface, with the engine module 100 between the engine block 164 and oil pan 166.

In certain embodiments, an engine comprising an engine module 100 is balanced by either a second engine module 100 or a “dummy” module having a piston weight driven by the working module. Such a configuration provides for smooth, balanced operation of the engine. An engine can comprise two or more engine modules 100 in nearly any configuration. In particular embodiments, engine modules 100 are provided in pairs. In a particular embodiment, an engine comprises at least two horizontally-opposed engine modules 100 (FIGS. 13-14).

The engine module 100 can be adapted to use any fuel type, such as, for example, gasoline, diesel, bio-diesel, propane, natural gas, and ethanol. The engine module 100 and associated parts or systems can be modified or adapted using known means to allow for the use of a particular fuel type.

The materials used in the overall construction and manufacture of the engine module 100 is expected to be similar to those presently used in the construction and manufacture of internal combustion engines, and can include, for example, aluminum, steel, rubber, plastics, and automotive-type gaskets. Materials used in bearings, such as the retention bearing 114, support bearing(s) 116, and bearings of piston pins 138 will generally be of high-grade steel or similar materials. A softer surface coating may be applied to the surfaces of the power stroke tracks 104 and outside track 108 of the flywheel 102 to help reduce shock loads to the piston pins 138.

Other components and parts of the engine module 100 do not differ or differ very little from those already well known and used in the field of internal combustion engines. Any one of a variety of methods for gas exchange can be used, including but not limited to puppet valves, rotary valves, ports, etc. For example, the cylinder head 140 may comprise intake means and exhaust means. In one embodiment, the cylinder head comprises intake port(s) 142, and exhaust port(s) 144, intake valve(s) 154, intake valve spring(s) 180, exhaust valve(s) 158, and exhaust valve spring(s) 182 (FIGS. 4-6). The various valves retained by the cylinder head 140 can be covered by the valve cover 178. The cylinder 124 and cylinder head 140 can be either a single part, or a separate cylinder head 140 can be mounted to a cylinder 124.

Because other components and parts are similar to those known in the art, other parts and functions of the engine module 100 or engine comprising two or more engine modules 100 are not discussed in detail, discussed very little, or not discussed. Examples of components parts, and functions not discussed include, for example, ignition systems, cooling systems, compression ratios, combustion chamber sealing, fuel delivery systems, turbocharging, supercharging, lubricating means, maintenance procedures, manufacturing procedures, etc. Despite the differences in the fundamental operation of an engine module 100 compared to that of other engines, those components, parts, and systems not discussed in detail, discussed very little, or not discussed herein will be familiar to those of ordinary skill in the art, and can be readily adapted to function with the engine module 100.

Throughout the description of the invention, the amount of rotation of the flywheel for intake and combustion are constrained, as the amount of rotation during compression and exhaust are constrained. However, the amount of rotation during intake and combustion may be unconstrained from the amount of rotation during compression and exhaust. Those skilled in the art will understand manufacture of an engine that performs the compression and exhaust cycles more quickly and in fewer degrees of rotation than the intake and combustion cycles in accordance with the principles of the invention as described herein.

Further, the stroke of intake and compression are unconstrained from the stroke of combustion and exhaust. Those skilled in the art will understand manufacture of an engine that has shorter intake and compression strokes than combustion and exhaust strokes in accordance with the principles of the invention as described herein.

Further, more than one track may exist on the flywheel for any particular stroke.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiments disclosed herein contemplated for carrying out this invention, but that the invention will include all embodiments falling within the scope of the claims.

What is claimed is:

1. A four-stroke internal combustion engine module comprising:
a cylinder having at least on piston pin travel slot;
a flywheel rotatably mounted to said cylinder;
at least one power stroke track having a sloped and curved power stroke surface disposed within said cylinder;
an outer track having at least one sloped compression and exhaust stroke surface and at least one sloped intake stroke surface positioned on a surface of said flywheel;
a piston head disposed within said cylinder;
at least one piston rod connected to said piston head; and
a piston pin connected to each of said at least one piston rod at an end opposite of that connected to said piston head, said piston pin positioned to extend into said at least one piston pin travel slot of said cylinder, a first end of said piston pin remaining within said cylinder that engages said sloped and curved power stroke surface of said at least one power stroke track during a power stroke of said four-stroke engine to rotate said flywheel or said cylinder, and a second end of said piston pin opposite to said first end that engages said at least one sloped compression and exhaust stroke surface and said at least one sloped intake stroke surface of said outer track during compression, exhaust, and intake strokes of said four-stroke engine module to move said piston head during said compression, exhaust, and intake strokes.

2. The four-stroke internal combustion engine module of claim 1, wherein said cylinder is adapted to be mountable to a mounting surface and said flywheel rotates around said cylinder during said power stroke of said four-stroke engine.

3. The four-stroke internal combustion engine module of claim 1, wherein said flywheel is adapted to be mountable to a mounting surface and said cylinder rotates within said flywheel during said power stroke of said four-stroke engine.

4. The four-stroke internal combustion engine module of claim 1, wherein:
said first end of said piston pin engages said sloped and curved power stroke surface of said at least one power stroke track as said piston head is forced downward during a power stroke, said sloped and curved power stroke surface having a variable slope and curvature that is sufficient to cause said flywheel or cylinder to rotate, converting linear reciprocating energy from said piston head into rotational movement of said flywheel or cylinder, and wherein and said rotational movement of said flywheel or cylinder caused during said power stroke causes engagement of said second end of said piston pin with said at least one sloped compression and exhaust stroke surface during said compression and exhaust strokes or said at least one intake stroke surface during said intake stroke, converting said rotational movement of said flywheel or cylinder into a linear movement of said piston head within said cylinder.

5. The four-stroke internal combustion engine module of claim 1, wherein said at least one power stroke track having a sloped and curved power stroke surface is positioned at a center of said flywheel.

6. The four-stroke internal combustion engine module of claim 1, further comprising a final drive adapted to be driven by a rotational movement of said flywheel around said cylinder or by a rotational movement of said cylinder within said flywheel.

7. The four-stroke internal combustion engine module of claim 2, further comprising a cylinder mounting block capable of facilitating mounting said cylinder to said mounting surface.

8. The four-stroke internal combustion engine module of claim 3, further comprising a flywheel mounting block capable of facilitating mounting said flywheel to said mounting surface.

9. The four-stroke internal combustion engine module of claim 1, further comprising an engine block and an oil pan, wherein said engine module is located between said engine block and said oil pan.

10. The four-stroke internal combustion engine module of claim 1, wherein said flywheel is rotatably mounted to said cylinder by a retention bearing.

11. The four-stroke internal combustion engine module of claim 1, further comprising at least one support bearing positioned between said surface of said flywheel and a wall of said cylinder that separates said wall of said cylinder from said surface of said flywheel while allowing for rotation of said flywheel around said cylinder or of said cylinder within said flywheel.

12. The four-stroke internal combustion engine module of claim 1, further comprising at least one bearing positioned on said at least one piston pin to reduce friction between said at least one piston pin and at least one surface chosen from said piston pin travel slot, said sloped and curved power stroke surface, said at least one sloped compression and exhaust stroke surface, and said at least one sloped intake stroke surface.

13. The four-stroke internal combustion engine module of claim 1, wherein said slopes of said sloped and curved power stroke surface, said at least one sloped compression and exhaust stroke surface, and said at least one sloped intake stroke surface result in a greater angular displacement of said flywheel around said cylinder during said power stroke and said intake stroke than during said compression stroke and exhaust stroke.

14. The four-stroke internal combustion engine module of claim 1, wherein said slopes of said sloped and curved power stroke surface, at least one sloped compression and exhaust stroke surface, and said at least one sloped intake stroke surface result in low internal stress and friction within said engine module.

15. The four-stroke internal combustion engine module of claim 1, wherein said slope of said sloped and curved power stroke surface is shallower near said top of said at least one power stroke track than towards said bottom of said at least one power stroke track.

16. The four-stroke internal combustion engine module of claim 1, wherein a diameter of said flywheel is sufficiently large to allow for said slopes of said sloped and curved power stroke surface, at least one sloped compression and exhaust stroke surface, and said at least one sloped intake stroke surface to be shallow while covering only a small rotation of said flywheel or said cylinder as measured in degrees.

17. The four-stroke internal combustion engine module of claim 2, wherein said flywheel further comprises an intake timing cam and an exhaust timing cam.

18. The four-stroke internal combustion engine module of claim 17, wherein intake and exhaust timing are controlled by said intake timing cam and said exhaust timing cam.

19. The four-stroke internal combustion engine module of claim 1, wherein intake and exhaust timing are controlled electronically.

20. The four-stroke internal combustion engine module of claim 6, wherein said final drive is chosen from a drive shaft, a drive chain, and a drive belt.

21. A four-stroke internal combustion engine comprising: at least one four-stroke internal combustion engine module of claim 1, an engine block, an oil pan, and a final drive.

22. The four-stroke internal combustion engine of claim 18, wherein said four-stroke internal combustion engine is balanced.

23. The four-stroke internal combustion engine of claim 19, wherein one working engine module of claim 1 is balanced by a second opposing engine module of claim 1 or by a dummy module having a piston weight driven by said one working engine module of claim 1.

24. The four-stroke internal combustion engine of claim 19, comprising at least one pair of horizontally opposed four-stroke internal combustion engine modules of claim 1.

25. The four-stroke internal combustion engine of claim 18, wherein said final drive is chosen from a drive shaft, a drive chain, and a drive belt.

26. A method of operating a four-stroke internal combustion engine comprising:
forcing a piston disposed within a cylinder to create a downward linear movement of said piston during a power stroke, causing a first end of at least one piston pin connected to said piston to engage and move downwardly along a sloped and curved power stroke surface of at least one power stroke track disposed within said cylinder;
converting linear movement of said piston into a rotational movement of a flywheel around said cylinder or of said cylinder within said flywheel, wherein the flywheel is rotatably mounted to said cylinder;
causing a second end of at least one piston pin connected to said piston to engage at least one sloped compression and exhaust stroke surface disposed on a surface of said flywheel at initiation of said exhaust stroke, causing said second end of at least one piston pin to be pushed up said at least one sloped power surface by said rotational movement of said flywheel or said cylinder and said piston to move upwardly within said cylinder;
causing said second end of at least one piston pin to engage at least one sloped intake stroke surface disposed on a surface of said flywheel at initiation of said intake stroke, causing said second of at least one piston pin to be dragged downwardly on said at least one sloped intake surface by the rotational movement of said flywheel or said cylinder and causing said piston to move downwardly within said cylinder; and
causing said second end of said at least one piston pin to engage said at least one sloped compression and exhaust stroke surface at initiation of said compression stroke, causing said second end of at least one piston pin to be pushed up said at least one sloped power surface by the rotational movement of said flywheel or said cylinder and causing said piston to move upwardly within said cylinder.

27. The method of claim 26, wherein rotational movement of said flywheel or said cylinder caused by said power stroke is converted into linear movement of said piston within said cylinder during said exhaust, intake, and compression strokes.

28. The method of claim 26, wherein the method is repeated to cause continuous operation of said four-stroke internal combustion engine.

29. The method of claim 26, further comprising connecting a final drive to said flywheel or said, causing said final drive to be driven by said rotational movement of said flywheel or said cylinder.

30. The method of claim 26, further comprising connecting said final drive to said flywheel or said cylinder directly.

31. The method of claim 26, further comprising connecting said final drive to said flywheel or said cylinder by one or more gears.

32. The method of claim 26, wherein said final drive is chosen from a drive shaft, a drive chain, and a drive belt.
